(19) United States
(12) Patent Application Publication
(10) Pub. No.: US 2026/0016571 A1
(43) Pub. Date: Jan. 15, 2026

(54) OPTICAL PROXIMITY SENSOR

(71) Applicant: Murata Manufacturing Co., Ltd., Nagaokakyo-shi, Kyoto-fu (JP)

(72) Inventors: Takatoshi KATO, Nagaokakyo-shi (JP); Hiroshi WATANABE, Nagaokakyo-shi (JP); Koichi INOUE, Nagaokakyo-shi (JP)

(21) Appl. No.: 19/336,837

(22) Filed: Sep. 23, 2025

Related U.S. Application Data
(63) Continuation of application No. PCT/JP2024/004287, filed on Feb. 8, 2024.

(30) Foreign Application Priority Data
Apr. 17, 2023 (JP) 2023-067112

(51) Int. Cl. G01S 7/481; G01S 17/04

(52) U.S. Cl. CPC G01S 7/4811; G01S 17/04

(57) ABSTRACT

An optical proximity sensor includes first and second optical functional portions. The first optical functional portion has a directivity characteristic in which an inclination angle when illuminance or light receiving sensitivity in a direction inclined from a reference direction that provides maximum illuminance or maximum light receiving sensitivity becomes about ½ of the illuminance or the light receiving sensitivity in the reference direction is equal to or smaller than about 15°. The second optical functional portion is operable with each of different two directivity characteristics. The first and second optical functional portions are positioned to enable one of the first and second optical functional portions to receive a portion of light emitted from another of the first and second optical functional portions and that is reflected by a target object located in the reference direction.

### CROSS REFERENCE TO RELATED APPLICATIONS

This application claims the benefit of priority to Japanese Patent Application No. 2023-067112 filed on Apr. 17, 2023 and is a Continuation Application of PCT Application No. PCT/JP2024/004287 filed on Feb. 8, 2024. The entire contents of each application are hereby incorporated herein by reference.

### BACKGROUND OF THE INVENTION

### 1. Field of the Invention

The present invention relates to optical proximity sensors.

### 2. Description of the Related Art

An optical proximity sensor is publicly known. This optical proximity sensor detects, by a light receiving element, light that is radiated from a light emitting element and is reflected by a target object, and measures the distance to the target object (see, for example, Japanese Examined Patent Application Publication No. 62-17163). The optical proximity sensor disclosed in Japanese Examined Patent Application Publication No. 62-17163 includes one light receiving element and two pairs of light emitting elements disposed on one straight line. Two light emitting elements forming each pair of the two pairs of light emitting elements are driven by signals with phases shifted by 90°.

In the optical proximity sensor disclosed in Japanese Examined Patent Application Publication No. 62-17163, the light emitting elements are required to be disposed on each of both sides of the light receiving element. Thus, a large space for locating the light receiving element and the plurality of light emitting elements is required, and it is difficult to reduce the size of the optical proximity sensor.

### SUMMARY OF THE INVENTION

Example embodiments of the present invention provide optical proximity sensors each able to be reduced in size.

According to an example embodiment of the present invention, an optical proximity sensor includes a first optical functional portion to execute one of light emission and light reception, and a second optical functional portion to execute another of light emission and light reception; wherein the first optical functional portion has a directivity characteristic in which an inclination angle when illuminance or light receiving sensitivity in a direction inclined from a reference direction providing a maximum illuminance or a maximum light receiving sensitivity is about ½ of the illuminance or the light receiving sensitivity in the reference direction is equal to or smaller than about 15°, the second optical functional portion is operable with each of different two directivity characteristics, and the first optical functional portion and the second optical functional portion are positioned to enable one of the first optical functional portion and the second optical functional portion to receive a portion of light emitted from another of the first optical functional portion and the second optical functional portion and is reflected by a target object located in the reference direction.

The second optical functional portion is operable with each of the different two directivity characteristics, and the distance to the target object can be obtained based on a light reception level acquired with each of the two directivity characteristics. Ranging is possible with the first optical functional portion and the second optical functional portion. Thus, example embodiments of the present invention each enable the size of the optical proximity sensor to be reduced.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic sectional view of an optical proximity sensor according to a first example embodiment of the present invention.

FIG. 2 is a graph indicating an example of a single-body directivity characteristic of each of two optical elements of a second optical functional portion according to an example embodiment of the present invention.

FIG. 3 is a graph indicating the relationship between a distance z and a ratio S_{b}/Sₐ of light reception levels when angles ρ₁ and ρ₂ are about 30° and the single-body directivity characteristic of each of the optical elements is represented by FIG. 2.

FIGS. 4A and 4B are a plan view and a side view, respectively, of an optical proximity sensor according to an example embodiment of the present invention.

FIGS. 5A to 5C are graphs indicating a time change of the light reception levels Sₐ and S_{b} and a time change of the ratio Sₐ/S_{b} of the light reception levels.

FIG. 6 is a schematic sectional view of an optical proximity sensor according to a second example embodiment of the present invention.

FIG. 7 is a graph indicating a calculation result of the relationship between the distance z and a ranging error attributed to an angle.

FIG. 8A is a schematic sectional view of an optical proximity sensor according to a third example embodiment of the present invention, and FIG. 8B is a graph indicating the relationship between the distance from the geometric center of an active region of a first optical functional portion to a measured point of a target object and the ratio of the light reception levels.

FIG. 9 is a schematic sectional view of the second optical functional portion of an optical proximity sensor according to a fourth example embodiment of the present invention.

FIG. 10 is a schematic sectional view of the second optical functional portion of an optical proximity sensor according to a modification of the fourth example embodiment of the present invention.

FIG. 11 is a schematic sectional view of the second optical functional portion of an optical proximity sensor according to a fifth example embodiment of the present invention.

FIG. 12A is a schematic sectional view of the second optical functional portion of an optical proximity sensor according to a sixth example embodiment of the present invention, and FIG. 12B is a perspective view of a portion of one directivity characteristic adjustment structure.

FIG. 13 is a schematic sectional view of the second optical functional portion of an optical proximity sensor according to a seventh example embodiment of the present invention.

FIG. 14A is a schematic sectional view of the second optical functional portion of an optical proximity sensor according to a modification of the seventh example embodiment of the present invention, and FIG. 14B is a plan view depicting the positional relationship between two active regions.

FIG. 15A is a schematic plan view of an optical proximity sensor according to an eighth example embodiment of the present invention, and FIG. 15B is a sectional view along dashed-dotted line 15B-15B in FIG. 15A.

FIG. 16 is a schematic plan view of an optical proximity sensor according to a modification of the eighth example embodiment of the present invention.

FIG. 17 is a schematic sectional view of an optical proximity sensor according to a ninth example embodiment of the present invention.

### DETAILED DESCRIPTION OF THE EXAMPLE EMBODIMENTS

Example embodiments of the present invention will be described in detail below with reference to the drawings.

### First Example Embodiment

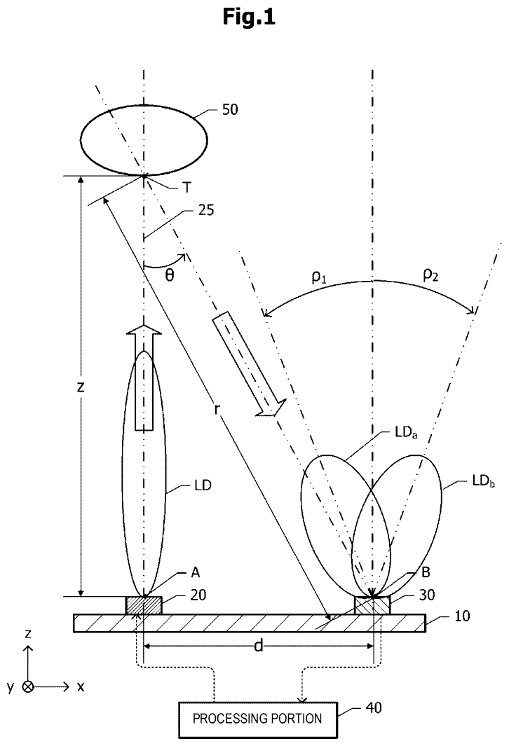

An optical proximity sensor according to a first example embodiment of the present invention is described with reference to drawings of FIGS. 1 to 5C.

FIG. 1 is a schematic sectional view of the optical proximity sensor according to the first example embodiment. A first optical functional portion 20 and a second optical functional portion 30 are disposed on an upper surface that is one surface of a substrate 10. For example, the first optical functional portion 20 has a light emitting function, and the second optical functional portion 30 has a light receiving function.

The first optical functional portion 20 has narrow directivity. In FIG. 1, an example of a directivity characteristic LD of the first optical functional portion 20 is expressed by a thin solid line. A virtual straight line that passes through a geometric center A of a light emitting region of the first optical functional portion 20 and extends in a direction that provides the maximum illuminance is referred to as reference axis 25. In the present specification, the light emitting region of the first optical functional portion 20 and a light receiving region of the second optical functional portion 30 are referred to as active regions.

A direction parallel or substantially parallel to the reference axis 25 is referred to as a reference direction. An xyz Cartesian coordinate system in which the direction parallel or substantially parallel to the reference axis 25 is regarded as a z-direction is defined. The first optical functional portion 20 and the second optical functional portion 30 are disposed along a virtual straight line parallel or substantially parallel to an x-axis. An orientation in which light is radiated from the first optical functional portion 20 is defined as the positive orientation of the z-axis, and an orientation from the first optical functional portion 20 toward the second optical functional portion 30 is defined as the positive orientation of the x-axis.

The first optical functional portion 20 emits light by control from a processing portion 40. A portion of the light radiated from the first optical functional portion 20 is reflected by a target object 50 located on the reference axis 25, and a portion of the reflected light is received by the second optical functional portion 30. A light reception level obtained by the second optical functional portion 30 is read into the processing portion 40. In FIG. 1, the orientations of the light that travels from the first optical functional portion 20 toward the target object 50 and the reflected light that travels from the target object 50 toward the second optical functional portion 30 are indicated by open arrows.

The second optical functional portion 30 can operate with each of two mutually different directivity characteristics (directivity characteristics of light receiving sensitivity). In FIG. 1, each of two different directivity characteristics LDₐ and LD_{b} is indicated by a thin solid line. The direction of the maximum light receiving sensitivity in one directivity characteristic LDₐ is inclined with respect to the z-direction toward the side of the first optical functional portion 20 (toward the negative side of the x-axis) by an angle ρ₁. The direction of the maximum light receiving sensitivity in the other directivity characteristic LD_{b} is inclined with respect to the z-direction toward the side remoter from the first optical functional portion 20 (toward the positive side of the x-axis) by an angle ρ₂.

The intersection of the reference axis 25 and the surface of the target object 50 (surface irradiated with the light from the first optical functional portion 20) is referred to as measured point T. The distance from the geometric center A of the active region of the first optical functional portion 20 to the measured point T is represented as z. The geometric center of the active region of the second optical functional portion 30 is represented as B. The distance from the geometric center B to the measured point T is represented as r. The angle between a line segment AT and a line segment BT is represented as θ. The distance in the x-direction from the geometric center A of the active region of the first optical functional portion 20 to the geometric center B of the active region of the second optical functional portion 30 is represented as d.

Next, a description is provided regarding a method for obtaining the distance z (FIG. 1) to the target object 50 by using the optical proximity sensor according to the first example embodiment. The reflectance of the surface of the target object 50 is represented as α. The maximum sensitivity of each of the two mutually different directivity characteristics LDₐ and LD_{b} of the second optical functional portion 30 is represented as G.

The directivity characteristics LDₐ and LD_{b} can be expressed as follows.

$$L {D}_{a} = {cos}^{m} β \qquad ( 1 )$$

$$L {D}_{b} = {cos}^{n} β$$

β is the inclination angle from the direction that provides the maximum sensitivity. n and m are parameters that determine the directivity characteristic.

The angle θ is expressed by the following formula.

$$θ = {tan}^{- 1} ( \frac{d}{z} ) \qquad ( 2 )$$

The distance r is expressed by the following formula.

$$r = \sqrt{{z}^{2} + {d}^{2}} \qquad ( 3 )$$

Light reception levels Sₐ and S_{b} when light is received with the directivity characteristics LDₐ and LD_{b}, respectively, are expressed by the following formulas.

$${S}_{a} = α G \frac{{cos}^{m} ( θ - {ρ}_{1} )}{{r}^{2}} \qquad ( 4 )$$

$${S}_{b} = α G \frac{{cos}^{n} ( θ + {ρ}_{2} )}{{r}^{2}}$$

The ratio of the light reception level S_{b} to the light reception level Sₐ is expressed by the following formula.

$$\frac{{S}_{b}}{{S}_{a}} = \frac{{cos}^{n} ( θ + {ρ}_{2} )}{{cos}^{m} ( θ - {ρ}_{1} )} \qquad ( 5 )$$

The angles ρ₁ and ρ₂ and the exponents m and n of the cosine functions in Formula (5) are known. Thus, the angle θ can be obtained analytically or by a numerical calculation from the ratio S_{b}/Sₐ of the light reception levels. Because the distance d in Formula (2) is known, the distance z can be obtained from the angle θ. In this manner, the distance z from the first optical functional portion 20 to the target object 50 can be obtained based on the ratio of the light reception levels of light reception with the two mutually different directivity characteristics LDₐ and LD_{b}.

The processing portion 40 (FIG. 1) receives the light reception levels Sₐ and S_{b} obtained by the second optical functional portion 30, and calculates the ratio S_{b}/Sₐ of the light reception levels. Moreover, the processing portion 40 obtains the distance z from the first optical functional portion 20 to the target object 50 based on the calculation value of the ratio S_{b}/Sₐ of the light reception levels. The obtained distance z is used in, for example, an application program.

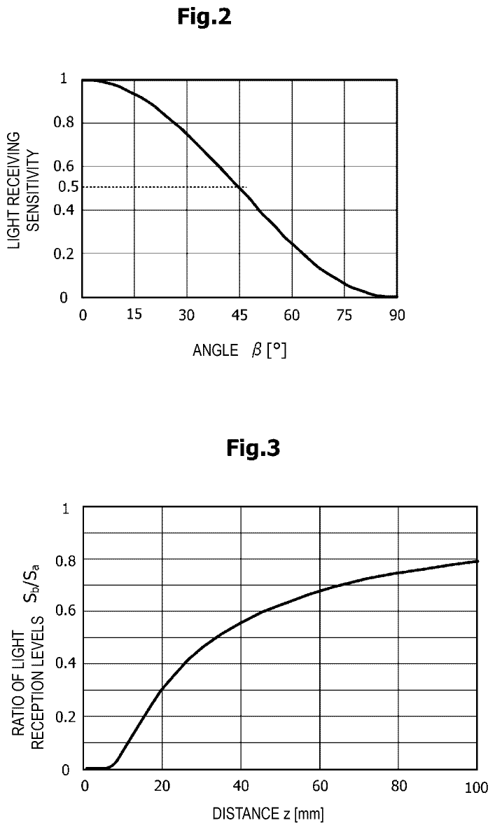

FIG. 2 is a graph indicating an example of each of the two directivity characteristics LDₐ and LD_{b} of the second optical functional portion 30. The horizontal axis represents the inclination angle β from the direction that gives the maximum sensitivity as an angle [°]. The vertical axis represents the light receiving sensitivity normalized such that the maximum value is defined as 1. In the example shown in FIG. 2, the half width at about half maximum concerning each of the directivity characteristics LDₐ and LD_{b} is about 45°.

FIG. 3 is a graph indicating the relationship between the distance z and the ratio S_{b}/Sₐ of the light reception levels when the angles ρ₁ and ρ₂ are about 30° and each of the directivity characteristics LDₐ and LD_{b} is represented by FIG. 2. The distance d from the first optical functional portion 20 to the second optical functional portion 30 was set to about 10 mm. The horizontal axis represents the distance z by a unit [mm]. The vertical axis represents the ratio S_{b}/Sₐ of the light reception levels. Each of the directivity characteristics LDₐ and LD_{b} when the inclination angle β from the direction of the maximum sensitivity is regarded as a variable is represented by FIG. 2, and both are the same or substantially the same. However, the directions that provide the maximum sensitivity in the directivity characteristics LDₐ and LD_{b} are inclined with respect to the z-direction toward the mutually different sides by the angles ρ₁ and ρ₂, respectively. Thus, the directivity characteristics LDₐ and LD_{b} when the z-direction is used as the basis are mutually different.

The ratio S_{b}/Sₐ of the light reception levels monotonically increases with respect to the distance z. As shown in the graph, the distance z is uniquely obtained when the ratio S_{b}/Sₐ of the light reception levels is obtained. If the processing portion 40 (FIG. 1) stores, in advance, the relationship between the distance z and the ratio S_{b}/Sₐ of the light reception levels indicated in FIG. 3, the processing portion 40 can calculate the ratio S_{b}/Sₐ of the light reception levels, and obtain the distance z based on the calculation result. It is sufficient for the processing portion 40 to store the relationship between the distance z and the ratio S_{b}/Sₐ of the light reception levels in, for example, a table format. The processing portion 40 may output the ratio S_{b}/Sₐ of the light reception levels to an application, and the application may calculate the distance z based on the ratio S_{b}/Sₐ of the light reception levels and the relationship indicated in FIG. 3.

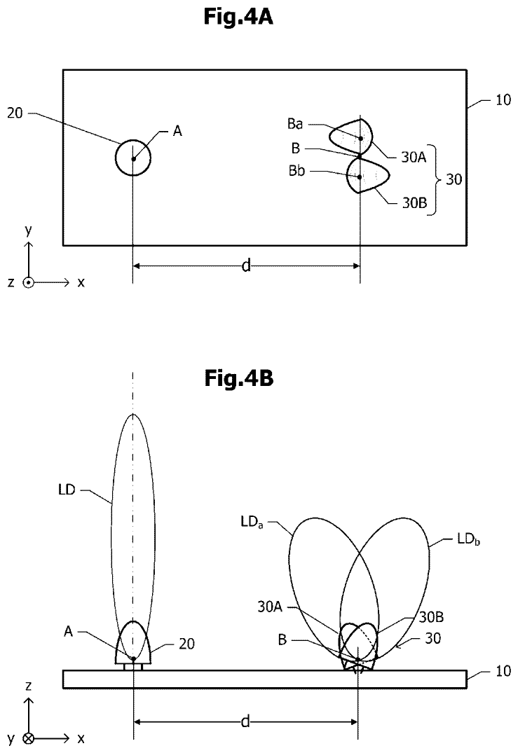

FIGS. 4A and 4B are a plan view and a side view, respectively, of the optical proximity sensor according to the first example embodiment. For the first optical functional portion 20, for example, a light emitting diode (LED), a vertical cavity surface emitting laser (VCSEL), or the like can be used. The directivity characteristic LD of the first optical functional portion 20 has narrow directivity. For example, it is preferable that an inclination angle (half width at half maximum concerning the directivity characteristic) when the illuminance or the light receiving sensitivity in a direction inclined from the reference direction that provides the maximum illuminance (z-direction) becomes about ½ of the illuminance in the reference direction is equal to or smaller than about 15°, and it is more preferable that the inclination angle be equal to or smaller than about 2°.

The second optical functional portion 30 includes two optical elements 30A and 30B providing a light receiving function. As the optical elements 30A and 30B, for example, photodiodes, phototransistors, CdS cells, or the like can be used. Each of the optical elements 30A and 30B includes an active region that receives light and a lens that focuses incoming light on the active region. The geometric centers of the active regions of the optical elements 30A and 30B are represented as Bₐ and B_{b}, respectively. The midpoint of a line segment with the two geometric centers Bₐ and B_{b} as both ends corresponds to the geometric center B (FIG. 1) of the active region of the second optical functional portion 30. The two optical elements 30A and 30B are arranged in a y-direction such that the positions in the x-direction of the geometric centers Bₐ and B_{b} of the respective active regions are the same or substantially the same.

Specifically, the geometric centers Bₐ and B_{b} of the respective active regions of the two optical elements 30A and 30B are provided at the same or substantially the same position in the x-direction. The distances in the x-direction from the geometric center A of the active region of the first optical functional portion 20 to the geometric centers Bₐ and B_{b} of the respective active regions of the two optical elements 30A and 30B are both d.

The single-body directivity characteristics of the two optical elements 30A and 30B are the same or substantially the same. That is, the exponents m and n of the cosine functions of Formula (1) are the same or substantially the same. The “single-body directivity characteristic” used herein means a directivity characteristic when the direction that provides the maximum illuminance or the maximum light receiving sensitivity is defined as 0°. The optical axis of the lens of one optical element 30A is inclined from the positive orientation of the z-axis toward the negative orientation of the x-axis (such an orientation to come closer to the first optical functional portion 20). The optical axis of the lens of the other optical element 30B is inclined from the positive orientation of the z-axis toward the positive orientation of the x-axis (such an orientation to be farther away from the first optical functional portion 20).

By inclining the optical axes of the respective lenses of the two optical elements 30A and 30B toward the different orientations in this manner, the second optical functional portion 30 can be operated with each of the two mutually different directivity characteristics LDₐ and LD_{b}. Here, modes of “operating the second optical functional portion 30 with each of the two directivity characteristics” include a mode in which the second optical functional portion 30 is operated at different timings between one directivity characteristic and the other directivity characteristic and two light reception results are obtained, and a mode in which the second optical functional portion 30 is simultaneously operated in terms of time and a light reception result based on one directivity characteristic and a light reception result based on the other directivity characteristic are independently obtained.

Each of the two optical elements 30A and 30B has a directivity characteristic with a wider angle than that of the first optical functional portion 20. For example, an inclination angle (half width at half maximum concerning the directivity characteristic) when the light receiving sensitivity in a direction inclined from the direction that provides the maximum light receiving sensitivity becomes about ½ of the light receiving sensitivity in the direction that provides the maximum light receiving sensitivity is approximately 45° as exemplified in FIG. 2.

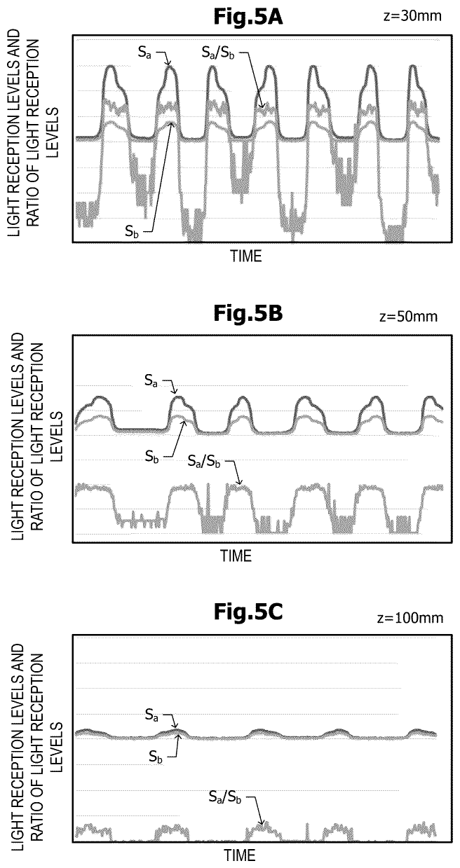

Next, with reference to FIGS. 5A to 5C, a description is provided of a result of execution of an evaluation experiment in which the ratio S_{b}/Sₐ of the light reception levels was obtained by using the optical proximity sensor depicted in FIGS. 4A and 4B. In the evaluation experiment, a target object including two surface regions with different values of the reflectance was reciprocated in a direction intersecting the reference axis 25 (FIG. 1). The distance d (FIG. 1) from the first optical functional portion 20 to the second optical functional portion 30 was set to about 10 mm. The angles ρ₁ and ρ₂ (FIG. 1) were both set to about 30°.

FIGS. 5A to 5C are graphs indicating a time change of the light reception levels Sₐ and S_{b} and a time change of the ratio Sₐ/S_{b} of the light reception levels. Although Formula (5) expresses the light reception levels S_{b}/Sₐ, the reciprocal of the light reception levels S_{b}/Sₐ is indicated in FIGS. 5A to 5C. The horizontal axes of the graphs of FIGS. 5A to 5C represent time. The vertical axes represent the light reception levels and the ratio of the light reception levels by an arbitrary unit.

The graphs of FIGS. 5A to 5C indicate measurement results when the distance z (FIG. 1) from the first optical functional portion 20 to the target object was set to about 30 mm, about 50 mm, and about 100 mm, respectively. Curves Sₐ and S_{b} in each graph indicate the light reception levels obtained by the optical elements 30A and 30B, respectively. A curve Sₐ/S_{b} indicates the ratio Sₐ/S_{b} of the light reception levels.

During periods in which the target object intersected the reference axis 25 (FIG. 1), the light reception levels Sₐ and S_{b} became high. When the target object deviated from the reference axis 25, the light reception levels Sₐ and S_{b} became almost zero. The reason why time zones in which the light reception levels Sₐ and S_{b} were relatively high and time zones in which they were relatively low appeared is because the region with relatively high reflectance and the region with relatively low reflectance were set in the surface of the target object. During periods in which the region with the higher reflectance intersected the reference axis 25, the light reception levels Sₐ and S_{b} became relatively high. During periods in which the region with the lower reflectance intersected the reference axis 25, the light reception levels Sₐ and S_{b} became relatively low.

The ratios Sₐ/S_{b} of the light reception levels are equal or substantially equal between the period in which the light reception levels Sₐ and S_{b} are relatively high and the period in which the light reception levels Sₐ and S_{b} are relatively low. Moreover, the ratio Sₐ/S_{b} of the light reception levels depends on the distance z, and the ratio Sₐ/S_{b} of the light reception levels becomes lower as the distance z becomes longer. The ratio S_{b}/Sₐ of the light reception levels, which is the reciprocal thereof, becomes higher as the distance z becomes longer as shown in FIG. 3.

From the evaluation experiment concerning which the results are indicated in FIGS. 5A to 5C, it has been confirmed that the distance z can be obtained based on the ratio S_{b}/Sₐ of the light reception levels. Moreover, the distance z to the target object can be obtained irrespective of the reflectance of the surface of the target object.

Next, excellent effects of the first example are described.

In a case in which a light receiving element is disposed at each of a plurality of different locations for one light emitting element and a target object is observed from a plurality of directions, the inclination of the surface of the target object with respect to each of the observation directions from the plurality of light receiving elements is not necessarily constant. When the inclination of the surface of the target object differs, apparent illuminance also differs. Thus, in a case of measuring the illuminance to execute ranging, it is required to correct the apparent illuminance attributed to the inclination of the target object and execute calculation of the ranging.

In contrast, in the first example embodiment, the geometric centers Bₐ and B_{b} of the respective active regions of the two optical elements 30A and 30B of the second optical functional portion 30 are not required to be disposed at different locations, and the two optical elements 30A and 30B are disposed such that both the geometric centers substantially correspond with each other or be close to each other. Therefore, there is substantially no difference in the inclination of the surface of the target object 50 between when the measured point T of the target object 50 is viewed from the optical element 30A and when the measured point T is viewed from the optical element 30B. Thus, ranging with high accuracy can be executed so as to be hardly affected by the inclination of the surface of the target object 50.

Further, in the first example embodiment, ranging is enabled by the first optical functional portion 20 and the second optical functional portion 30 including the two optical elements 30A and 30B disposed close to each other. Thus, the size of the sensor can be reduced compared with the optical proximity sensor in which one light receiving element and two or more light emitting elements are disposed at different positions.

Moreover, in the first example embodiment, the distance to the target object 50 (FIG. 1) can be obtained based on the ratio S_{b}/Sₐ of the light reception levels. Thus, an excellent effect that an algorithm to obtain the distance is simplified is obtained.

Next, an optical proximity sensor according to a modification of the first example of the present invention is described.

In the first example embodiment, the first optical functional portion 20 has the light emitting function, and the second optical functional portion 30 has the light receiving function. Conversely, the first optical functional portion 20 may have the light receiving function, and the second optical functional portion 30 may have the light emitting function. In this case, the directivity characteristic LD of the first optical functional portion 20 is a directivity characteristic of the light receiving sensitivity, and the directivity characteristics LDₐ and LD_{b} of the second optical functional portion 30 are directivity characteristics of the illuminance.

In the first example embodiment, the direction that provides the maximum light receiving sensitivity in one directivity characteristic LDₐ is inclined toward the negative orientation of the x-axis, and the direction that provides the maximum light receiving sensitivity in the other directivity characteristic LD_{b} is inclined toward the positive orientation of the x-axis. However, the orientations of the inclination are not limited to this example embodiment. The directions that provides the maximum light receiving sensitivity in the two directivity characteristics LDₐ and LD_{b} may be inclined from the positive orientation of the z-axis toward the same orientation of the x-axis by different angles. Further, the direction that provides the maximum light receiving sensitivity in one of the directivity characteristics LDₐ and LD_{b} may be parallel or substantially parallel to the z-axis. For example, the inclination angles ρₐ and ρ_{b} may be several degrees, or may be close to about 90°.

The two directivity characteristics LDₐ and LD_{b} can be in various relationships. However, for uniquely obtaining the distance z based on the ratio S_{b}/Sₐ of the light reception levels, it is preferable to set the two directivity characteristics LDₐ and LD_{b} such that the ratio S_{b}/Sₐ of the light reception levels monotonically increases or monotonically decreases with respect to the distance z in a target range of ranging. However, when the motion of the target object 50 is known in advance, for example, when it is known in advance that the target object 50 gradually approaches the first optical functional portion 20 from the certain distance z, the ratio S_{b}/Sₐ of the light reception levels is not necessarily required to monotonically increase or monotonically decrease with respect to the distance z.

When both of the two optical elements 30A and 30B of the second optical functional portion 30 are non-directional, the light reception level does not change depending on the angle θ (FIG. 1), and thus it is impossible to execute ranging by using the ranging algorithm of the optical proximity sensor according to the first example embodiment.

At least one of the two optical elements 30A and 30B is required to have directivity. There is no particular limit on the half width at half maximum of the directivity characteristic. However, if the half width at half maximum is too small, when the angle θ (FIG. 1) comes close to about 90°, the light reception level becomes too low and ranging is greatly affected by noise. Conversely, if the half width at half maximum is too large, when the distance z is s increased, the change amount of the light reception level in association with the change amount of the distance z becomes small and ranging becomes susceptible to the influence of noise. It is preferable to optimally design parameters such as the distance d from the first optical functional portion 20 to the second optical functional portion 30 and the half width at half maximum of the directivity characteristic depending on the target range of ranging.

### Second Example Embodiment

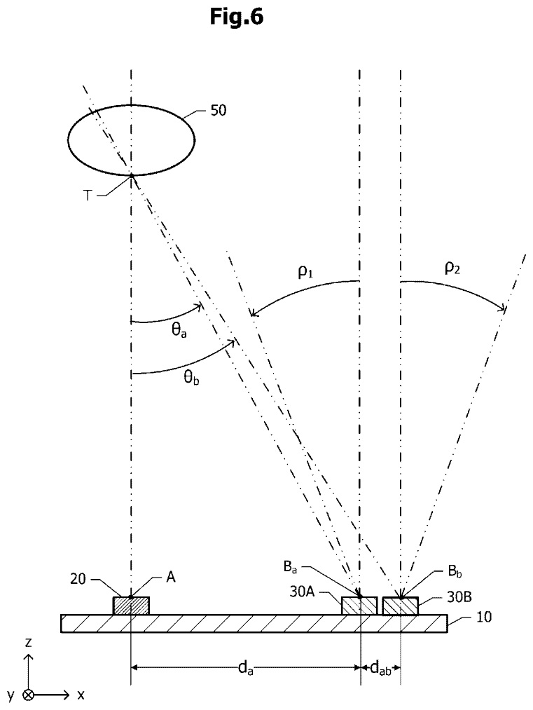

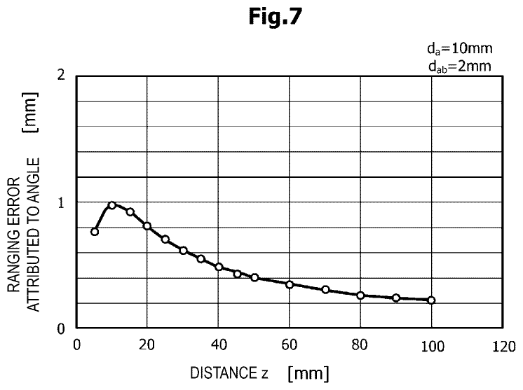

Next, an optical proximity sensor according to a second example embodiment of the present invention is described with reference to FIGS. 6 and 7. In the following, description is omitted concerning a configuration in common with the optical proximity sensor according to the first example embodiment described with reference to the drawings of FIGS. 1 to 5C.

FIG. 6 is a schematic sectional view of the optical proximity sensor according to the second example embodiment. In the first example embodiment (FIGS. 4A and 4B), the two optical elements 30A and 30B of the second optical functional portion 30 are arranged in the y-direction. In the second example, the two optical elements 30A and 30B are arranged in the x-direction. The geometric center of the active region of the optical element 30A closer to the first optical functional portion 20 is represented as Bₐ. The geometric center of the active region of the optical element 30B farther from the first optical functional portion 20 is represented as B_{b}. The distance from the geometric center A of the active region of the first optical functional portion 20 to the geometric center Bₐ of the active region of the optical element 30A is represented as dₐ. The distance between the geometric centers Bₐ and B_{b} of the two optical element 30A and 30B is represented as d_{ab}.

The angle between the line segment AT and a line segment BₐT is represented as θₐ. The angle between the line segment AT and a line segment BT is represented as θ_{b}. Because the angles θₐ and θ_{b} are different, the apparent illuminance when the measured point T of the target object 50 is viewed from one optical element 30A is different from the apparent illuminance when the measured point T of the target object 50 is viewed from the other optical element 30B. A ranging error possibly occurs in a calculation value of the distance z due to this difference in the apparent illuminance.

FIG. 7 is a graph indicating a calculation result of the relationship between the distance z and the ranging error attributed to the angle. The distance dₐ was set about 10 mm, and the distance d_{ab} was set to about 2 mm. The horizontal axis represents the distance z by a unit [mm]. The vertical axis represents the ranging error by a unit [mm]. As a reference value of the ranging result, a ranging result in a case in which the surface of the target object 50 was parallel or substantially parallel to the substrate 10 and the two optical element 30A and 30B of the second optical functional portion 30 were disposed at a position to which the distance in the x-direction from the geometric center A of the active region of the first optical functional portion 20 was dₐ+d_{ab}/2 was used. The difference between the ranging result when the distance d_{ab} was not zero and this reference value was defined as the ranging error.

The ranging error became the maximum when the distance z was about 10 mm, and the ranging error at the time was at most about 1 mm. Ranging can be executed with a ranging error of about 10% or lower when the distance d_{ab} is equal to or shorter than about 20% of the distance dₐ.

Next, excellent effects of the second example are described.

The distance z can be measured even when the two optical elements 30A and 30B of the second optical functional portion 30 are arranged in the x-direction as in the second example embodiment. In this case, for example, it is preferable to set the distance d_{ab} between the geometric centers Bₐ and B_{b} of the active regions of the two optical elements 30A and 30B to be equal to or shorter than about 20% of the distance dₐ.

Next, a modification of the second example embodiment is described.

Although the two optical elements 30A and 30B are arranged in the x-direction in the second example embodiment, they may be arranged in a direction oblique to the x-direction. Also in this configuration, for example, it is preferable to set the distance between the geometric centers Bₐ and B_{b} of the active regions of the two optical elements 30A and 30B to be equal to or shorter than about 20% of the shorter distance of the distances from the geometric center A of the active region of the first optical functional portion 20 to the geometric centers of the respective active regions of the two optical elements 30A and 30B.

Moreover, when the two optical elements 30A and 30B are arranged in the y-direction as in the first example embodiment (FIG. 4A), the difference between the apparent illuminance when the measured point T of the target object 50 is viewed from one optical element 30A and the apparent illuminance when the measured point T of the target object 50 is viewed from the other optical element 30B is smaller than that in the case of the second example embodiment. Also in this case, ranging can be executed with sufficiently high accuracy when the distance between the geometric centers Bₐ and B_{b} of the active regions of the two optical elements 30A and 30B is set equal to or shorter than about 20% of the distance d.

### Third Example Embodiment

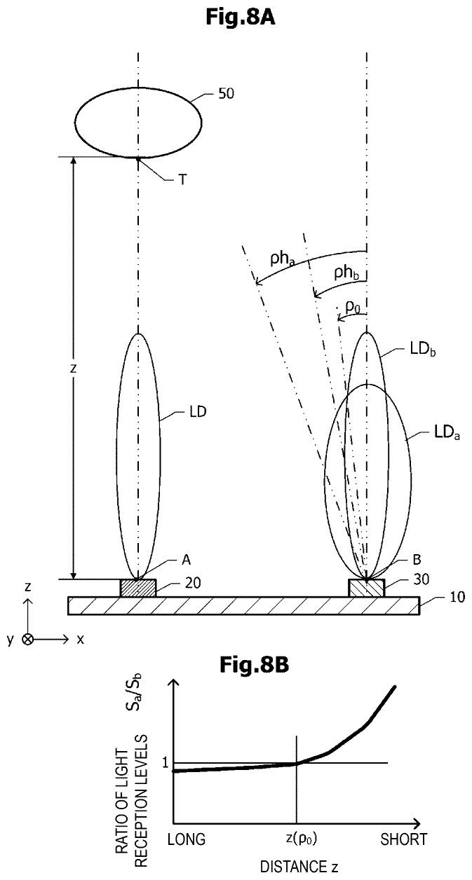

Next, an optical proximity sensor according to a third example embodiment of the present invention is described with reference to FIGS. 8A and 8B. In the following, description is omitted concerning a configuration in common with the optical proximity sensor according to the first example embodiment described with reference to the drawings of FIGS. 1 to 5C.

FIG. 8A is a schematic sectional view of the optical proximity sensor according to the third example embodiment. In the first example embodiment (FIG. 1), the two directivity characteristics LDₐ and LD_{b} of the second optical functional portion 30 are made different by inclining the directions of the maximum light receiving sensitivity in the two directivity characteristics LDₐ and LD_{b} into mutually different orientations. In contrast, in the third example embodiment, the directions that provide the maximum light receiving sensitivity in the two directivity characteristics LDₐ and LD_{b} are both parallel or substantially parallel to the z-axis, and half angles at half maximum ρhₐ and ρh_{b} of both are different. For example, the half angle at half maximum ρhₐ of the directivity characteristic LDₐ is larger than the half angle at half maximum ρh_{b} of the directivity characteristic LD_{b}. When the inclination angle from the z-direction toward the side of the first optical functional portion 20 is ρ₀, the light receiving sensitivities of the two directivity characteristics LDₐ and LD_{b} are equal or substantially equal.

FIG. 8B is a graph indicating the relationship between the distance z from the geometric center A of the active region of the first optical functional portion 20 to the measured point T of the target object 50 and the ratio Sₐ/S_{b} of the light reception levels. The horizontal axis represents the distance z. The vertical axis represents the ratio Sₐ/S_{b} of the light reception levels. The right orientation of the horizontal axis indicates an orientation in which the distance z becomes shorter. When the distance z has a magnitude corresponding to the angle ρ₀, the ratio Sₐ/S_{b} of the light reception levels becomes about 1.

Next, excellent effects of the third example embodiment are described. Also in the third example embodiment, the second optical functional portion 30 can operate with each of the mutually different two directivity characteristics LDₐ and LD_{b}. Thus, similarly to the first example embodiment, the distance z can be obtained based on a calculation value of the ratio Sₐ/S_{b} of the light reception levels.

### Fourth Example Embodiment

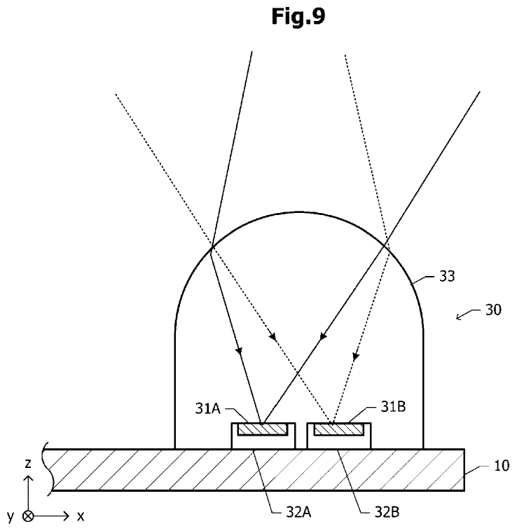

Next, an optical proximity sensor according to a fourth example embodiment of the present invention is described with reference to FIG. 9. In the following, description is omitted concerning a configuration in common with the optical proximity sensor according to the first example embodiment described with reference to the drawings of FIGS. 1 to 5C.

FIG. 9 is a schematic sectional view of the second optical functional portion 30 of the optical proximity sensor according to the fourth example. In the first example embodiment (FIGS. 4A and 4B), one lens is provided for the active region of one optical element 30A, and another lens is provided for the active region of the other optical element 30B. In the fourth example embodiment, two semiconductor chips 32A and 32B are mounted on the substrate 10. Active regions 31A and 31B are provided in the semiconductor chips 32A and 32B, respectively. The active regions 31A and 31B have a light receiving function.

One collecting optical component 33 is provided for the two active regions 31A and 31B. For example, a collecting lens is used as the collecting optical component 33. The collecting optical component 33 causes a portion of light reflected by the target object 50 on the reference axis 25 (FIG. 1) to be incident on the two active regions 31A and 31B. The two active regions 31A and 31B are disposed at mutually different positions in the direction (x-direction) from the first optical functional portion 20 (FIG. 1) toward the optical axis of the collecting optical component 33. Thus, the directivity characteristic of the light receiving sensitivity when one active region 31A is operated and the directivity characteristic of the light receiving sensitivity when the other active region 31B is operated are mutually different.

Next, excellent effects of the fourth example are described. Also in the fourth example embodiment, because the directivity characteristic of the light receiving sensitivity when one active region 31A is operated and the directivity characteristic of the light receiving sensitivity when the other active region 31B is operated are mutually different, the distance z (FIG. 1) to the target object 50 can be obtained based on the ratio of the light reception levels obtained by the two active regions 31A and 31B similarly to the first example embodiment.

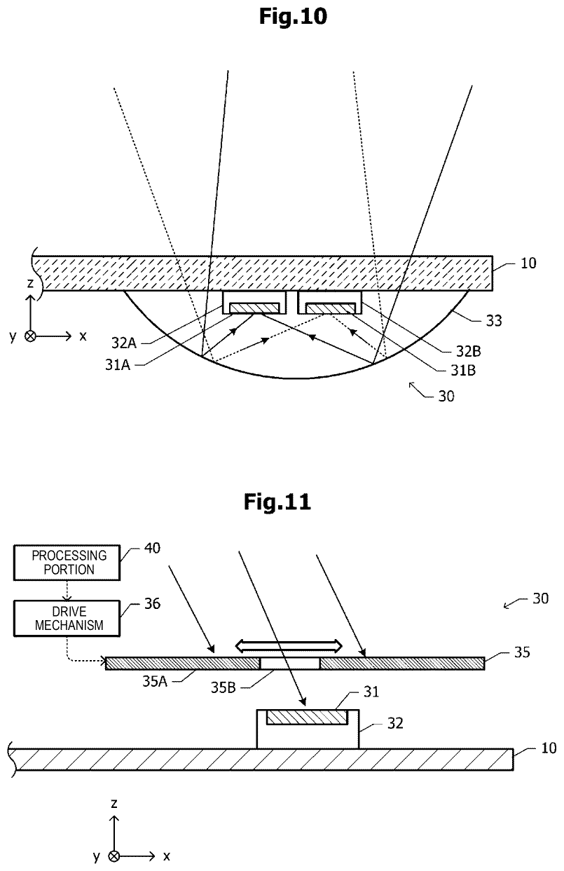

Next, an optical proximity sensor according to a modification of the fourth example embodiment is described with reference to FIG. 10. FIG. 10 is a schematic sectional view of the second optical functional portion 30 of the optical proximity sensor according to the modification of the fourth example embodiment. In the fourth example embodiment (FIG. 9), the second optical functional portion 30 is disposed on the surface oriented toward the side on which the target object 50 (FIG. 1) to be detected is disposed, of both surfaces of the substrate 10. In contrast, in the present modification, the second optical functional portion 30 is disposed on the surface on the opposite side to the surface oriented toward the side on which the target object 50 (FIG. 1) to be detected is disposed, of both surfaces of the substrate 10.

In the fourth example embodiment, the lens is used as the collecting optical component 33. In the present modification, for example, a concave mirror is used. The substrate 10 is transparent in a wavelength region of light radiated from the first optical functional portion 20. A portion of light reflected by the target object 50 (FIG. 1) is transmitted through the substrate 10, and is reflected by the collecting optical component 33 that is the concave mirror and is incident on the two active regions 31A and 31B. The concave mirror may be used as the collecting optical component 33 as in the present modification.

Next, an optical proximity sensor according to another modification of the fourth example embodiment is described.

In the fourth example embodiment, the first optical functional portion 20 has the light emitting function, and the second optical functional portion 30 has the light receiving function. Conversely, the first optical functional portion 20 may have the light receiving function, and the second optical functional portion 30 may have the light emitting function. In this case, the collecting optical component 33 propagates a portion of light radiated from the two active regions 31A and 31B of the second optical functional portion 30 toward the target object 50 on the reference axis 25 (FIG. 1).

Further, although the two active regions 31A and 31B are provided in the different semiconductor chips 32A and 32B, respectively, in the fourth example embodiment, the two active regions 31A and 31B may be provided in one semiconductor chip. When the second optical functional portion 30 has the light receiving function, for example, it is sufficient to provide two photodiodes in one semiconductor chip. When the second optical functional portion 30 has the light emitting function, for example, a multi-emitter VCSEL including two active regions can be used as the second optical functional portion 30.

### Fifth Example Embodiment

Next, an optical proximity sensor according to a fifth example embodiment of the present invention is described with reference to FIG. 11. In the following, description is omitted concerning a configuration in common with the optical proximity sensor according to the first example embodiment described with reference to the drawings of FIGS. 1 to 5C.

FIG. 11 is a schematic sectional view of the second optical functional portion 30 of the optical proximity sensor according to the fifth example embodiment. In the first example embodiment (FIGS. 4A and 4B), the second optical functional portion 30 includes two active regions. In contrast, in the fifth example embodiment, the second optical functional portion 30 includes one active region 31 provided in a semiconductor chip 32. A partial light-shielding plate 35 is disposed on the front side (positive side of the z-axis) of the active region 31. The partial light-shielding plate 35 includes a light-shielding region 35A and a transmissive region 35B. A drive mechanism 36 changes the position of the partial light-shielding plate 35 in the x-direction by control from the processing portion 40. This changes the position of the transmissive region 35B relative to the active region 31 in the x-direction.

A portion of light reflected by the target object 50 on the reference axis 25 (FIG. 1) is transmitted through the transmissive region 35B of the partial light-shielding plate 35, and is incident on the active region 31. When the position of the transmissive region 35B in the x-direction changes, the directivity characteristic of the light receiving sensitivity of the light receiving component including the partial light-shielding plate 35 and the active region 31 changes. By changing the position of the transmissive region 35B in the x-direction, the one active region 31 can be operated with two mutually different directivity characteristics.

Next, excellent effects of the fifth example embodiment are described. Also in the fifth example embodiment, because the active region 31 can be operated with two mutually different directivity characteristics, the distance z (FIG. 1) to the target object 50 can be obtained based on the ratio of the light reception levels obtained by the active region 31 when the active region 31 is operated with each of the two directivity characteristics similarly to the first example embodiment.

Next, an optical proximity sensor according to a modification of the fifth example embodiment is described.

In the fifth example embodiment, two directivity characteristics are provided by moving the partial light-shielding plate 35 in the x-direction. In addition, it is also possible to provide two directivity characteristics by swinging a reflecting mirror. Moreover, in the fifth example embodiment, the position of the transmissive region 35B relative to the active region 31 in the x-direction is changed by mechanically moving the partial light-shielding plate 35. However, for example, a liquid crystal panel may be used as the partial light-shielding plate 35. It is sufficient to use, as the liquid crystal panel, one that can independently improve the transmittance of regions at two locations at different positions in the x-direction.

### Sixth Example Embodiment

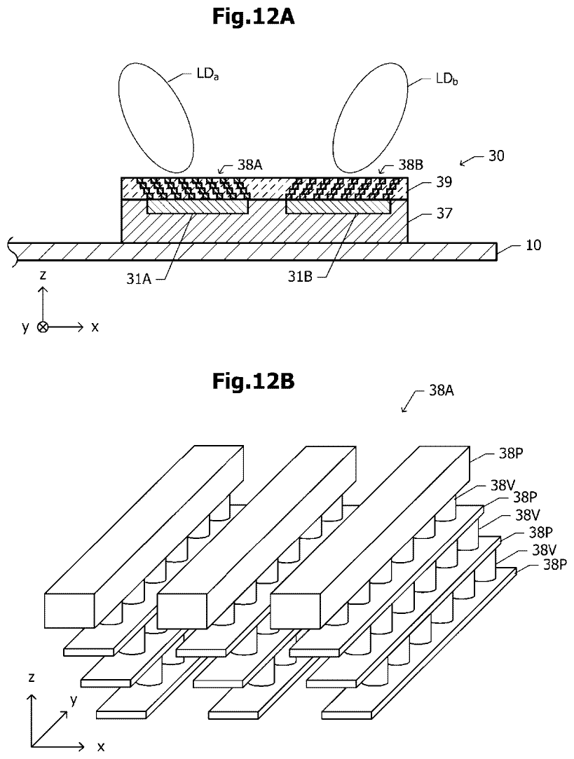

Next, an optical proximity sensor according to a sixth example embodiment of the present invention is described with reference to FIGS. 12A and 12B. In the following, description is omitted concerning a configuration in common with the optical proximity sensor according to the first example embodiment described with reference to the drawings of FIGS. 1 to 5C.

FIG. 12A is a schematic sectional view of the second optical functional portion 30 of the optical proximity sensor according to the sixth example embodiment. Two active regions 31A and 31B are provided in one surface of a common substrate 37. As the common substrate 37, a semiconductor substrate, for example, a Si substrate, a GaAs substrate, a Gap substrate, or the like can be used.

Directivity characteristic adjustment structures 38A and 38B are disposed above the active regions 31A and 31b, respectively. The directivity characteristic adjustment structures 38A and 38B are made of a material that is opaque in the wavelength region of the light radiated from the first optical functional portion 20 (FIG. 1). As the opaque material, a metal, for example, Cu, Al, WSi, or the like can be used. Further, the directivity characteristic adjustment structures 38A and 38B are embedded in a transparent film 39 made of a transparent material. As the transparent material, a dielectric material, for example, SiN, SiO₂, SiON, or the like can be used.

FIG. 12B is a perspective view of a portion of one directivity characteristic adjustment structure 38A. The directivity characteristic adjustment structure 38A includes a plurality of opaque patterns 38P and a plurality of opaque vias 38V. Each of the plurality of opaque patterns 38P has a shape elongated in the y-direction. Moreover, the plurality of opaque patterns 38P are disposed at positions corresponding to a plurality of intersections (plurality of grid points of a parallelogram grid) of a plurality of straight lines parallel or substantially parallel to the x-axis in an xz-section (horizontal-direction grid lines) and a plurality of mutually parallel or substantially parallel straight lines inclined with respect to the z-axis (height-direction grid lines). The height-direction grid lines of the directivity characteristic adjustment structures 38A and 38B are inclined toward mutually opposite orientations with respect to the z-direction.

Two opaque patterns 38P adjacent to each other in the z-direction are mutually connected by the plurality of opaque vias 38V. The opaque pattern 38P farther from the active region 31A of the two opaque patterns 38P connected by the opaque vias 38V is shifted in the negative orientation of the x-axis relative to the opaque pattern 38P closer to the active region 31A.

The other directivity characteristic adjustment structure 38B (FIG. 12A) also includes a plurality of opaque patterns 38P and a plurality of opaque vias 38V similarly to the directivity characteristic adjustment structure 38A. In the directivity characteristic adjustment structure 38B, the opaque pattern 38P farther from the active region 31B of the two opaque patterns 38P connected by the opaque vias 38V is shifted in the positive orientation of the x-axis relative to the opaque pattern 38P closer to the active region 31A.

Light incident on the second optical functional portion 30 passes through the transparent region in which neither the opaque pattern 38P nor the opaque via 38V is disposed, and reaches each of the active regions 31A and 31B. Thus, the direction of the maximum sensitivity in the directivity characteristic LDₐ (FIG. 2A) of the light receiving sensitivity of the active region 31A is parallel or substantially parallel to a direction resulting from inclining a vector in the positive orientation of the z-axis toward the negative side of the x-axis. Conversely, the direction of the maximum sensitivity in the directivity characteristic LD_{b} (FIG. 2A) of the light receiving sensitivity of the other active region 31B is parallel or substantially parallel to a direction resulting from inclining the vector in the positive orientation of the z-axis toward the positive side of the x-axis.

Next, excellent effects of the sixth example embodiment are described.

The two mutually different directivity characteristics LDₐ and LD_{b} can be achieved by providing the directivity characteristic adjustment structures 38A and 38B for the active regions 31A and 31B, respectively, as in the sixth example embodiment. Further, the two active regions 31A and 31B and the directivity characteristic adjustment structures 38A and 38B are provided in and on the common substrate 37. Thus, the number of components can be reduced compared with the case in which the second optical functional portion 30 includes the two optical elements 30A and 30B as in the first example (FIGS. 4A and 4B).

### Seventh Example Embodiment

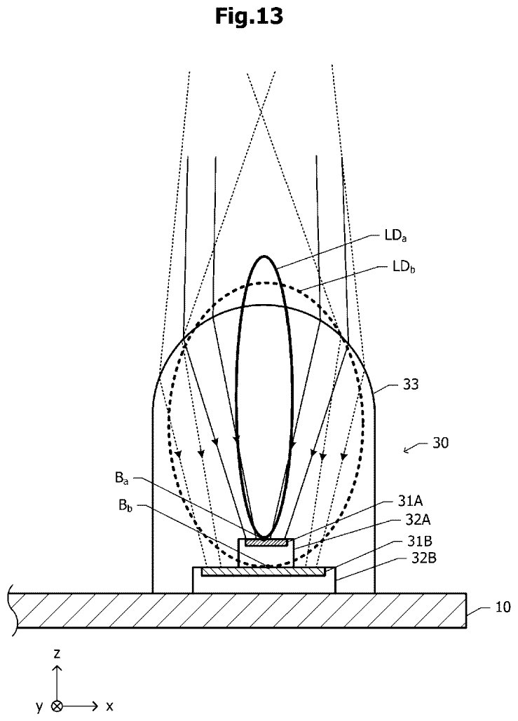

Next, an optical proximity sensor according to a seventh example embodiment of the present invention is described with reference to FIG. 13. In the following, description is omitted concerning a configuration in common with the optical proximity sensor according to the fourth example embodiment described with reference to FIG. 9.

FIG. 13 is a schematic sectional view of the second optical functional portion 30 of the optical proximity sensor according to the seventh example embodiment. In the fourth example embodiment (FIG. 9), the two active regions 31A and 31B of the second optical functional portion 30 are disposed at different positions in the x-direction. In contrast, in the seventh example embodiment, the semiconductor chip 32A in which the active region 31A is provided is stacked on the semiconductor chip 32B in which the active region 31B is made. The respective geometric centers Bₐ and B_{b} of the two active regions 31A and 31B are disposed at the same or substantially the same position in an xy-plane. For example, the geometric centers Bₐ and B_{b} are disposed on the optical axis of the collecting optical component 33 and near the focal point of the collecting optical component 33.

When the substrate 10 is viewed in plan view, the active region 31B on the lower side (side of the substrate 10) extends to the outside of the semiconductor chip 32A thereon. Light incident on the second optical functional portion 30 is focused by the collecting optical component 33, and is incident on the two active regions 31A and 31B. Because the active region 31B extends to the outside of the active region 31A in plan view, the directivity characteristic LD_{b} of the light receiving sensitivity of the active region 31B has a wider angle than the directivity characteristic LDₐ of the light receiving sensitivity of the active region 31A.

Next, excellent effects of the seventh example embodiment are described.

Also in the seventh example embodiment, the second optical functional portion 30 can operate with each of mutually different two directivity characteristics LDₐ and LD_{b}. Thus, similarly to the first example embodiment, the distance to the target object 50 (FIG. 1) can be obtained based the ratio of the light reception levels obtained by each of the two active regions 31A and 31B. Moreover, in the seventh example embodiment, the geometric centers Bₐ and B_{b} of the two active regions 31A and 31B are disposed at the same or substantially the same position in the xy-plane. This can reduce the ranging error attributed to the angle, described with reference to FIGS. 6 and 7.

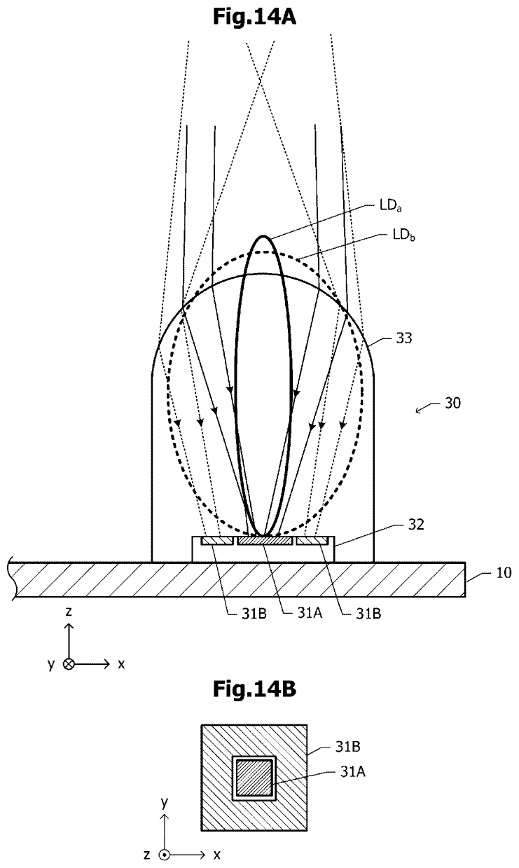

Next, an optical proximity sensor according to a modification of the seventh example embodiment is described with reference to FIGS. 14A and 14B.

FIG. 14A is a schematic sectional view of the second optical functional portion 30 of the optical proximity sensor according to the present modification. FIG. 14B is a plan view depicting the positional relationship between the two active regions 31A and 31B. In the seventh example embodiment (FIG. 13), the two semiconductor chips 32A and 32B are stacked in the z-direction. In the present modification, the two active regions 31A and 31B are provided in one semiconductor chip 32. In plan view, one active region 31B surrounds the other active region 31A. In FIG. 14B, the active region 31A is shown with right-upward relatively dense hatching, and the active region 31B is shown with right-downward relatively sparse hatching.

Even when the configuration in which the two active regions 31A and 31B are provided in the one semiconductor chip 32 is provided as in the present modification, the distance to the target object 50 (FIG. 1) can be obtained based on the ratio of the light reception levels obtained by each of the two active regions 31A and 31B similarly to the seventh example embodiment (FIG. 13). Further, in the present modification, the number of semiconductor chips can be reduced compared with the seventh example (FIG. 13).

### Eighth Example Embodiment

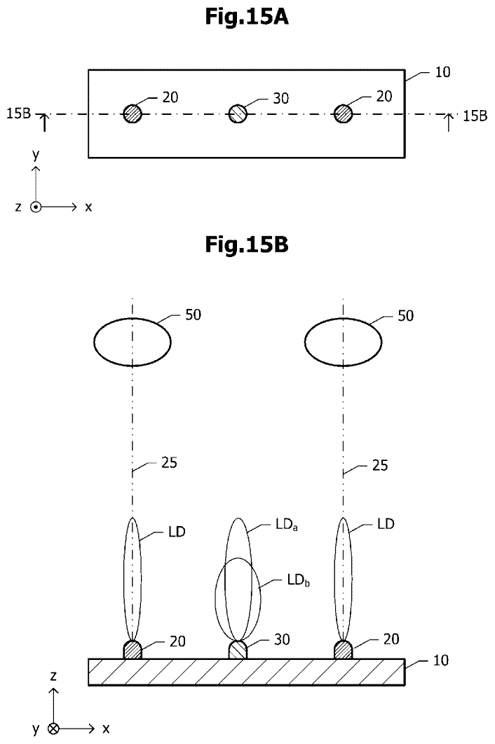

Next, an optical proximity sensor according to an eighth example embodiment of the present invention is described with reference to FIGS. 15A and 15B. In the following, description is omitted concerning a configuration in common with the optical proximity sensor according to the first example embodiment described with reference to the drawings of FIGS. 1 to 5C.

FIG. 15A is a schematic plan view of the optical proximity sensor according to the eighth example embodiment. FIG. 15B is a sectional view along dashed-dotted line 15B-15B in FIG. 15A. In the first example embodiment (FIG. 1), one first optical functional portion 20 and one second optical functional portion 30 are provided. In contrast, in the eighth example embodiment, two first optical functional portions 20 are provided for one second optical functional portion 30. When the substrate 10 is viewed in plan view, the one second optical functional portion 30 is disposed at the midpoint of a line segment with the two first optical functional portions 20 as both ends. In FIG. 15A, the first optical functional portions 20 are shown with right-upward relatively dense hatching, and the second optical functional portion 30 is shown with right-downward relatively sparse hatching. An xyz Cartesian coordinate system is defined in which the direction of the straight line along which the two first optical functional portions 20 and the one second optical functional portion 30 are arranged is regarded as an x-direction and the direction perpendicular or substantially perpendicular to the surface of the substrate 10 is regarded as a z-direction.

The direction that provides the maximum illuminance of each of the two first optical functional portions 20 is parallel or substantially parallel to the z-direction similarly to the case of the first example embodiment (FIG. 1). The directions that provide the maximum light receiving sensitivity in the two mutually different directivity characteristics LDₐ and LD_{b} of the light receiving sensitivity of the second optical functional portion 30 are parallel or substantially parallel to the z-axis similarly to the case of the third example embodiment (FIG. 8A). Moreover, the half widths at half maximum of the directivity characteristics LDₐ and LD_{b} are mutually different.

When one first optical functional portion 20 and the second optical functional portion 30 are operated, the distance to a target object on the reference axis 25 of the first optical functional portion 20 can be obtained. When the two first optical functional portions 20 are operated such that the operation timings are mutually shifted, the first optical functional portion 20 has the reference axis 25 on which the target object is located can be determined.

Next, excellent effects of the eighth example are described.

In the eighth example embodiment, it is possible to detect not only the distance to the target object but also the movement of the target object in the x-direction.

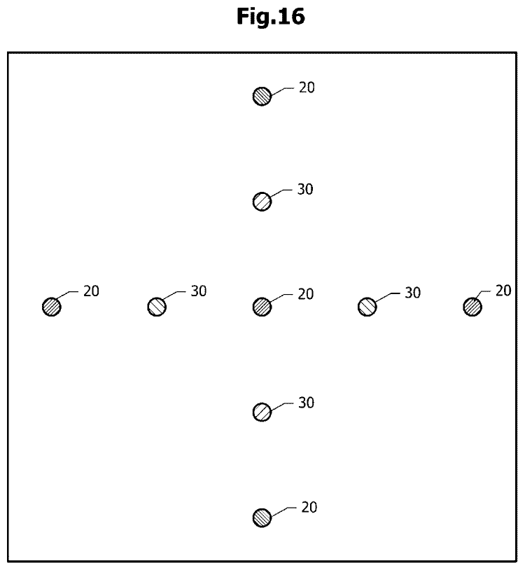

Next, an optical proximity sensor according to a modification of the eighth example embodiment of the present invention is described with reference to FIG. 16. FIG. 16 is a schematic plan view of the optical proximity sensor according to the modification of the eighth example. In the present modification, a plurality of first optical functional portions 20 and a plurality of second optical functional portions 30 are provided along two mutually orthogonal or substantially orthogonal straight lines. The first optical functional portion 20 is disposed at the intersection of these two straight lines. The second optical functional portion 30 is disposed at each of four locations at an equal or substantially equal distance from the intersection on the two straight lines. In addition, the first optical functional portion 20 is disposed at a position farther than each of the four second optical functional portions 30 as viewed from the intersection.

In the present modification, the movement of a target object in a two-dimensional plane can be detected. For example, in a case in which the optical proximity sensor according to the modification of the eighth example embodiment is mounted on a controller operated through tilting a thumb stick left and right, the tilt direction and the tilt angle of the thumb stick can be detected.

### Ninth Example Embodiment

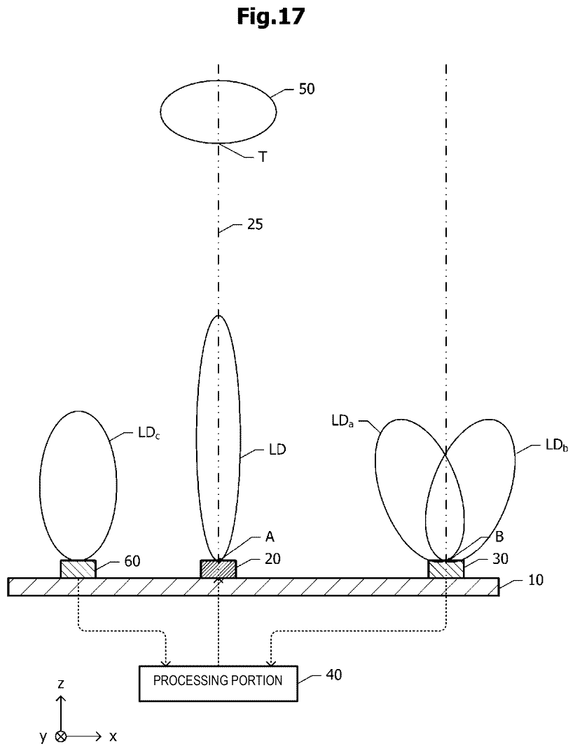

Next, an optical proximity sensor according to a ninth example embodiment of the present invention is described with reference to FIG. 17. In the following, description is omitted concerning a configuration in common with the optical proximity sensor according to the first example embodiment described with reference to the drawings of FIGS. 1 to 5C.

FIG. 17 is a schematic sectional view of the optical proximity sensor according to the ninth example embodiment. The optical proximity sensor according to the ninth example embodiment includes the first optical functional portion 20 and the second optical functional portion 30 similarly to the optical proximity sensor according to the first example embodiment (FIG. 1), and further includes a third optical functional portion 60. The third optical functional portion 60 receives a portion of light that is radiated from the first optical functional portion 20 and is reflected by the target object 50. The second optical functional portion 30 can operate with each of the two mutually different directivity characteristics LDₐ and LD_{b}, whereas the third optical functional portion 60 operates with one directivity characteristic LD_{c}. The third optical functional portion 60 is disposed on the opposite side to the second optical functional portion 30 as viewed from the first optical functional portion 20.

Next, excellent effects of the ninth example are described.

Also in the ninth example embodiment, the distance to the target object 50 can be obtained similarly to the first example embodiment. Further, the inclination angle in the x-direction of the surface at the measured point T of the target object 50 can be obtained by comparing the light reception level obtained by the second optical functional portion 30 with the light reception level obtained by the third optical functional portion 60.

It is obvious that the above-described respective example embodiments and modifications thereof have been provided as examples and partial replacement or combination of configurations shown in different example embodiments is possible. The same or similar operations and advantageous effects by a similar configuration in a plurality of example embodiments are not described for every example embodiment. Moreover, the present invention is not limited to the above-described example embodiments. For example, it will be obvious to those skilled in the art that various changes, improvements, combinations, and the like are possible.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An optical proximity sensor comprising:
a first optical functional portion to execute one of light emission and light reception; and
a second optical functional portion to execute another of light emission and light reception; wherein
the first optical functional portion has a directivity characteristic in which an inclination angle when illuminance or light receiving sensitivity in a direction inclined from a reference direction that provides maximum illuminance or maximum light receiving sensitivity becomes about ½ of illuminance or light receiving sensitivity in the reference direction is equal to or smaller than about 15°;
the second optical functional portion is operable with each of two different directivity characteristics; and
the first optical functional portion and the second optical functional portion are positioned to enable one of the first optical functional portion and the second optical functional portion to receive a portion of light that is emitted from another of the first optical functional portion and the second optical functional portion and reflected by a target object located in the reference direction.

2. The optical proximity sensor according to claim 1, wherein
the second optical functional portion includes two optical elements with mutually different directivity characteristics; and
a distance between geometric centers of active regions that are light emitting regions or light receiving regions of the two optical elements of the second optical functional portion is equal to or shorter than about 20% of a shorter distance of distances from a geometric center of an active region that is a light emitting region or a light receiving region of the first optical functional portion to the geometric centers of the respective active regions of the two optical elements of the second optical functional portion.

3. The optical proximity sensor according to claim 2, wherein the two optical elements have a same directivity characteristic as a single body, and are positioned with mutually different postures with respect to the reference direction.

4. The optical proximity sensor according to claim 1, wherein
the second optical functional portion includes:
two active regions to perform light emission or light reception; and
a collecting optical component to cause a portion of light from a target object on a straight line extending in the reference direction from the first optical functional portion to be incident on the two active regions or to focus a portion of light radiated from the two active regions toward the target object on the straight line extending in the reference direction from the first optical functional portion; and
the two active regions are provided at mutually different positions of a direction from the first optical functional portion toward an optical axis of the collecting optical component.

5. The optical proximity sensor according to claim 1, wherein
the second optical functional portion includes:
one active region that is a light emitting region or a light receiving region; and
a partial light-shielding plate including a light-shielding region to block a portion of light coming toward the active region or light radiated from the active region and a transmissive region to allow a portion of the light coming toward the active region or the light radiated from the active region to be transmitted through the transmissive region; and
a position of the transmissive region relative to the active region is variable.

6. The optical proximity sensor according to claim 1, wherein
the second optical functional portion includes:
two active regions provided in a common substrate to perform one of light emission and light reception; and
a directivity characteristic adjustment structure on the substrate and to cause directivity characteristics of light radiated from the two active regions or directivity characteristics of light receiving sensitivity of light reception by the two active regions to be mutually different.

7. The optical proximity sensor according to claim 1, wherein
the second optical functional portion includes:
two active regions to perform one of light emission or light reception; and
a collecting optical component to cause a portion of light from a target object on a straight line extending in the reference direction from the first optical functional portion to be incident on the two active regions or to focus a portion of light radiated from the two active regions toward the target object on the straight line extending in the reference direction from the first optical functional portion;
a geometric center of each of the two active regions is located on an optical axis of the collecting optical component; and
the collecting optical component provides mutually different values of a half angle at half maximum to directivity characteristics of the two active regions.

8. The optical proximity sensor according to claim 1, wherein the second optical functional portion includes one second optical functional portion, and the first optical functional portion is provided at at least two locations on a flat surface orthogonal or substantially orthogonal to the reference direction for the one second optical functional portion.

9. The optical proximity sensor according to claim 1, further comprising:
a processor configured or programmed to calculate a ratio of a light reception level obtained by the first optical functional portion or the second optical functional portion when the first optical functional portion is operated and the second optical functional portion is operated with each of the directivity characteristics mutually different.

10. The optical proximity sensor according to claim 9, wherein the processor is configured or programmed to calculate a distance to the target object located in the reference direction on a basis of the ratio.

11. The optical proximity sensor according to claim 1, wherein a distance between the first optical functional portion to the second optical functional portion is about 10 mm.

12. The optical proximity sensor according to claim 1, wherein the first optical functional portion includes a light emitting diode or a vertical cavity surface emitting laser.

13. The optical proximity sensor according to claim 1, wherein the second optical functional portion includes photodiodes, phototransistors, or CdS cells.

14. The optical proximity sensor according to claim 7, wherein the collecting optical component includes a concave mirror.

15. The optical proximity sensor according to claim 6, wherein the two active regions are defined by two semiconductors.

16. The optical proximity sensor according to claim 6, wherein the common substrate is a semiconductor substrate.

17. The optical proximity sensor according to claim 16, wherein the semiconductor substrate include Si, GaAs, or GaP.

18. The optical proximity sensor according to claim 6, wherein the characteristic adjustment structure includes an opaque material.

19. The optical proximity sensor according to claim 6, wherein the characteristic adjustment structure is embedded in a transparent film.

20. The optical proximity sensor according to claim 19, wherein the transparent film includes SiN, Sio, or SiON.
